(19) United States
(12) Patent Application Publication
(10) Pub. No.: US 2013/0252213 A1
(43) Pub. Date: Sep. 26, 2013

(54) WATER PIPE ASSEMBLY FOR PUMP TRAINING

(71) Applicant: Clayton Anthony Gridley, Canton, GA (US)

(72) Inventor: Clayton Anthony Gridley, Canton, GA (US)

(21) Appl. No.: 13/430,576

(22) Filed: Mar. 26, 2012

(51) Int. Cl. G09B 19/00

(52) U.S. Cl. 434/226

(57) ABSTRACT

A water pipe assembly for pump training is provided. In at least one embodiment, a water pipe assembly for pump training includes: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread. In at least one embodiment, a multiplicity of water pipe assemblies for pump training is provided in a pump training systems.

### FIELD OF THE INVENTION

The technology described herein relates generally to water pipe assemblies, pump training equipment, pump testing equipment, and associated methods and procedures for pump training. More specifically, this technology relates to a fire fighter's water pipe assembly for pump training and fire pump training operations.

### BACKGROUND OF THE INVENTION

Firefighting equipment, such as a fire truck, or the like, is typically equipped with one or more onboard pumps capable of drawing water from a water source. The water is drawn into the pump at a high flow rate from the water source. The one or more onboard pumps are configured to pump the drawn water under high pressure through one or more fire hoses. The water source for the pumps can be a natural water source such as a pond, lake, or river, or a manmade source such as a swimming pool, or other standing body of water. Additionally, water sources can include fire hydrants, portable water tanks, and the like.

These onboard pumps should be tested regularly according to guidelines set by the National Fire Protection Association (NFPA). Many fire departments lack the resources to conduct adequate, regular tests of pumping equipment. The testing procedure requires a pump to be tested at various flow rates for predetermined lengths of time, which results in vast quantities of water pumped through the equipment. Fire hydrants alone are generally not capable of supplying fresh water at the high flow rates necessary for the length of time necessary to conduct the pumping tests. Such tests require a large amount of water.

By way of example, conventional methods of testing the pumps of a fire truck require positioning a fire truck adjacent to a large body of water with the intake hose positioned within the water for drawing significant amounts of water into the pumps. This water is typically not recirculated, wasting the water.

Related utility patents known in the art include the following:

U.S. Pat. No. 7,644,776, issued to Holley et al. on Jan. 12, 2012, discloses a preassembled water transfer pipe for use in a fire fighting system includes a generally hollow conduit member formed from a predetermined material and having each of a predetermined length and a predetermined cross sectional shape and a connection member equipped with a predetermined size connection for receiving a hose one of thereon and therein disposed at one end of said generally hollow conduit member. There is a pipe support assembly disposed at an opposed end of such generally hollow conduit member.

U.S. Pat. No. 6,386,049, issued to Schrumm on May 14, 2002, discloses a pump flow test system for accurately measuring the aggregate fluid flow from all pumps of a fire truck. The inventive device includes a reservoir structure for storing a volume of fluid, an intake manifold having a plurality of intake inlets extending into the reservoir structure, an elongate tube extending into the reservoir structure from the intake manifold, a pitot tube positioned within the elongate tube for measuring fluid flow, and a meter attached to the pitot tube for displaying the water flow through the elongate tube. The elongate tube preferably has a cap and a perforated portion for allowing even distribution of the incoming water into the reservoir structure. In use, an intake hose is positioned within the reservoir structure for drawing water into the pumps of the fire truck. A plurality of dispensing hoses is connected to the pump of the fire truck and to the intake inlets of the intake manifold for delivering the water from the pumps of the fire truck to the reservoir structure.

U.S. Pat. No. 7,827,860, issued to Weis on Nov. 9, 2010, discloses a pump testing apparatus includes a tank mounted on a mobile trailer for testing water pumps associated with firefighting equipment. Two rotatable draft tubes extend into the tank for drawing water from the lower part of the tank through suction hoses connected to the pump being tested. Two inlet manifolds receive water discharged from the pump being tested and direct the water into respective flow stations that measure the water flow rate. The water is then dispersed back into the tank. The tank has a system of baffles to prevent cavitation of the water circulating through the tank. A cooling system is provided to cool the water within the tank to maintain a desired water temperature during pump testing. The cooling system includes a supply line having a cool water inlet for connecting to a source of cool water, and cool water outlets at spaced locations throughout the tank.

U.S. Pat. No. 7,036,676, issued to Christensen on May 2, 2006, discloses a foldable water tank comprises a foldable receptacle having a bottom wall and vertical sidewalls, the sidewalls being inclined inwardly; and a plurality of support structures connected to the sidewalls to support the sidewalls in the inclined position.

U.S. Pat. No. 4,139,033, issued to Brown on Feb. 13, 1979, discloses a portable tank having a skeleton frame with a corner mounted fitting having an outlet discharging into the tank and an inlet for connection to a tank truck.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a fire fighter's water pipe assembly and associated systems and methods for pump training and fire pump training operations.

In one exemplary embodiment, the technology described herein provides a water pipe assembly for pump training. The water pipe assembly includes: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread.

In at least one embodiment of the water pipe assembly for pump training, the water transfer pipe is further configured and shaped for placement over an edge of a portable water reservoir, such that the water pipe assembly is free standing, without any requirement for mounting hardware.

In at least one embodiment, the water transfer pipe is comprised of aluminum.

In at least one embodiment, the water transfer pipe further includes: a first horizontal pipe configured to receive the first coupling adapter fluidly coupled and disposed at a first end of the water transfer pipe and configured to convert fire hose thread to pipe thread; a first vertical pipe fluidly coupled to the first horizontal pipe and extending upwardly from the first horizontal pipe; a second horizontal pipe fluidly coupled to the first vertical pipe and extending horizontally from the first vertical pipe; a second vertical pipe fluidly coupled to the second horizontal pipe and extending downwardly from the second horizontal pipe; and a third horizontal pipe fluidly coupled to the second vertical pipe and extending horizontally from the second vertical pipe. The first horizontal pipe, first vertical pipe, second horizontal pipe, second vertical pipe, third horizontal pipe are fluidly coupled by a ninety degree elbow. The first horizontal pipe, first vertical pipe, second horizontal pipe, second vertical pipe, third horizontal pipe are collectively form a shape adapted for placement over a portable water reservoir.

In at least one embodiment of the water pipe assembly for pump training, the first coupling adapter fluidly coupled and disposed at a first end of the water transfer pipe and configured to convert fire hose thread to pipe thread further comprises a female national hose thread (NH) to female national pipe tapered (NPT) swivel inlet, thereby to fluidly couple fire hose into pipe.

In at least one embodiment of the water pipe assembly for pump training, the second coupling adapter fluidly coupled and disposed at a second end of the water transfer pipe configured to convert pipe thread to fire hose thread further comprises a female national pipe tapered (NPT) to male national hose thread (NH) rigid outlet, thereby to fluidly couple pipe to fire nozzle.

In at least one embodiment of the water pipe assembly for pump training, the first coupling adapter fluidly coupled and disposed at a first end of the water transfer pipe and configured to convert fire hose thread to pipe thread further comprises a Siamese adapter such that it is configured to receive input from two fire hoses.

In another exemplary embodiment, the technology described herein provides a multiple water pipe assembly system for pump training. The multiple water pipe assembly system includes: a plurality of water pipe assemblies, each water pipe assembly comprising: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread.

In at least one embodiment of the multiple water pipe assembly system for pump training, each of the plurality of water pipe assemblies is varied in size to accommodate the varying size of fire hoses used by fire departments.

In at least one embodiment, the multiple water pipe assembly system for pump training further includes: a base upon which each of the plurality of water pipe assemblies is mounted, such that the plurality of water pipe assemblies are anchored together as an assembly, and such that the assembly forms a shape suitable to mount over an edge of a portable water reservoir.

In at least one embodiment, the multiple water pipe assembly system for pump training also includes: an inner bracket upon which each of the plurality of water pipe assemblies is mounted, such that the plurality of water pipe assemblies are anchored together as an assembly, and such that the assembly forms a shape suitable to mount over an edge of a portable water reservoir, the inner mount disposed on a side of the plurality of water pipe assemblies internal to the portable water reservoir when utilized with the portable water reservoir.

In at least one embodiment, the multiple water pipe assembly system for pump training further includes: an outer bracket upon which each of the plurality of water pipe assemblies is mounted, such that the plurality of water pipe assemblies are anchored together as an assembly, and such that the assembly forms a shape suitable to mount over an edge of a portable water reservoir, the outer mount disposed on a side of the plurality of water pipe assemblies external to the portable water reservoir when utilized with the portable water reservoir.

In at least one embodiment, each of the plurality of water pipe assemblies further includes: a first horizontal pipe configured to receive the first coupling adapter fluidly coupled and disposed at a first end of the water transfer pipe and configured to convert fire hose thread to pipe thread; a first vertical pipe fluidly coupled to the first horizontal pipe and extending upwardly from the first horizontal pipe; a second horizontal pipe fluidly coupled to the first vertical pipe and extending horizontally from the first vertical pipe; a second vertical pipe fluidly coupled to the second horizontal pipe and extending downwardly from the second horizontal pipe; and a third horizontal pipe fluidly coupled to the second vertical pipe and extending horizontally from the second vertical pipe. The first horizontal pipe, first vertical pipe, second horizontal pipe, second vertical pipe, third horizontal pipe are fluidly coupled by a ninety degree elbow. The first horizontal pipe, first vertical pipe, second horizontal pipe, second vertical pipe, third horizontal pipe are collectively form a shape adapted for placement over a portable water reservoir.

In at least one embodiment, each of the plurality of water pipe assemblies includes the first coupling adapter fluidly coupled and disposed at a first end of the water transfer pipe and configured to convert fire hose thread to pipe thread in each of the plurality of water pipe assemblies further comprises a female national hose thread (NH) to female national pipe tapered (NPT) swivel inlet, thereby to fluidly couple fire hose into pipe; and wherein the second coupling adapter fluidly coupled and disposed at a second end of the water transfer pipe configured to convert pipe thread to fire hose thread in each of the plurality of water pipe assemblies further comprises a female national pipe tapered (NPT) to male national hose thread (NH) rigid outlet, thereby to fluidly couple pipe to fire nozzle.

In another exemplary embodiment, the technology described herein provides a method for pump training utilizing a water pipe assembly. The method includes: utilizing a water pipe assembly for pump training comprising: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread; coupling the first coupling adapter to a fire hose; and coupling the second coupling adapter to a fire nozzle.

In at least one embodiment of the method for pump training utilizing a water pipe assembly, the method further includes: utilizing a single fire truck; utilizing an on-board water tank disposed within the single fire truck; utilizing a portable water tank; pumping from the single fire truck to the water pipe assembly and subsequently the portable water tank; and drafting from the portable water tank to the single fire truck such that water is recirculated.

In at least one embodiment of the method for pump training utilizing a water pipe assembly, the method further includes: utilizing a pair of fire trucks, a first truck being attack pumper, and a second truck being a source pumper; utilizing an on-board water tank disposed within each fire truck; utilizing a portable water tank; pumping from the first fire truck to the water pipe assembly and subsequently the portable water tank; drafting from the portable water tank to the second fire truck such that water is recirculated; and supplying water from the second truck to the first truck.

In at least one embodiment of the method for pump training utilizing a water pipe assembly, the method further includes: utilizing a trio of fire trucks, a first truck being a first attack pumper, a second truck being a second attack pumper, and a third truck being a source pumper; utilizing an on-board water tank disposed within each fire truck; utilizing a portable water tank; pumping from the first fire truck and the second fire truck to the water pipe assembly and subsequently the portable water tank; drafting from the portable water tank to the third fire truck, the source pumper; pumping utilizing relay pumping; and pumping utilizing dual pumping.

In at least one embodiment of the method for pump training utilizing a water pipe assembly, the method further includes: utilizing a trio of fire trucks, a first truck being an attack pumper, a second truck being a relay pumper, and a third truck being a source pumper; utilizing an on-board water tank disposed within each fire truck; pumping from the first fire truck to the water pipe assembly and subsequently the portable water tank; drafting from the portable water tank to the third fire truck, the source pumper; pumping utilizing relay pumping; pumping from the source pumper to the relay pumper; and pumping from the relay pumper to the attack pumper.

In at least one embodiment of the method for pump training utilizing a water pipe assembly, the method further includes: utilizing a trio of fire trucks, a first truck being an attack pumper, a second truck being a water tender, and a third truck being a source pumper; utilizing an on-board water tank disposed within each fire truck; pumping from the first fire truck, the attack pumper, to the water pipe assembly and subsequently the portable water tank; drafting from the portable water tank to the third fire truck, the source pumper; pumping to a water tender; tendering water to a water dump site; and drafting from the water dump site to the first fire truck, the attach pumper;

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a water pipe assembly for pump training configured for utilization mounted on a portable water tank, illustrating, in particular, a five-pipe assembly having various varying pipe sizes and varying inlet sizes, as well as a Siamese adapter on at least one pipe, according to an embodiment of the technology described herein;

FIG. 2 is a rear perspective view of the water pipe assembly for pump training configured for utilization mounted on a portable water tank, illustrating, in particular, a five-pipe assembly having various varying pipe sizes and varying inlet sizes, as well as a Siamese adapter on at least one pipe, according to an embodiment of the technology described herein;

FIG. 3 is a rear perspective view of the water pipe assembly for pump training configured for utilization mounted on a portable water tank, illustrating, in particular, a five-pipe assembly having various varying pipe sizes and varying inlet sizes, as well as a Siamese adapter on at least one pipe, according to an embodiment of the technology described herein;

FIG. 4 is a front perspective view of the water pipe assembly for pump training configured for utilization mounted on a portable water tank, illustrating, in particular, a five-pipe assembly having various varying pipe sizes and varying inlet sizes, as well as a Siamese adapter on at least one pipe, according to an embodiment of the technology described herein;

FIG. 5 is a perspective view of a Siamese adapter configured for use with the water pipe assembly for pump training depicted in FIGS. 1 to 4, according to an embodiment of the technology described herein;

FIG. 6 is a schematic diagram illustrating a method and procedures for use of a water pipe assembly for pump training in a one-truck system, utilizing an on-board water tank, a portable water tank, drafting operations, and having standard pumping, attack hose lays, and ground monitors or FDC, according to an embodiment of the technology described herein;

FIG. 7 is a schematic diagram illustrating a method and procedures for use of a water pipe assembly for pump training in a two-truck system, utilizing an on-board water tank, a portable water tank, pumping from a pressurized source, relay pumping, drafting operations, and having standard pumping, attack hose lays, and ground monitors or FDC, according to an embodiment of the technology described herein;

FIG. 8 is a schematic diagram illustrating a method and procedures for use of a water pipe assembly for pump training in a dual pumping system, utilizing an on-board water tank, a portable water tank, pumping from a pressurized source, relay pumping, drafting operations, dual pumping, and having standard pumping, attack hose lays, and ground monitors or FDC, according to an embodiment of the technology described herein;

FIG. 9 is a schematic diagram illustrating a method and procedures for use of a water pipe assembly for pump training in a relay pumping system, utilizing an on-board water tank, a portable water tank, pumping from a pressurized source, source/relay/attack pumping, drafting operations, and having standard pumping, attack hose lays, and ground monitors or FDC, according to an embodiment of the technology described herein;

FIG. 10 is a schematic diagram illustrating a method and procedures for use of a water pipe assembly for pump training in a shuttle operations system, utilizing multiple on-board water tanks, multiple portable water tanks, source/attack pumping, drafting operations, shuttle operations (including fill site, dump site, and water tenders) and having standard pumping, attack hose lays, and ground monitors or FDC, according to an embodiment of the technology described herein;

FIG. 11 is a top planar view of a pipe nipple;

FIG. 12 is a perspective view of a pipe nipple;

FIG. 13 is a front perspective view of a single pipe assembly for pump training configured for utilization mounted on a portable water tank, according to an embodiment of the technology described herein;

FIG. 14 is a first side view of the single pipe assembly depicted in FIG. 13 for pump training configured for utilization mounted on a portable water tank;

FIG. 15 is a second side view of the single pipe assembly depicted in FIG. 13 for pump training configured for utilization mounted on a portable water tank;

FIG. 16 is a first end view of the single pipe assembly depicted in FIG. 13 for pump training configured for utilization mounted on a portable water tank;

FIG. 17 is a second end view of the single pipe assembly depicted in FIG. 13 for pump training configured for utilization mounted on a portable water tank;

FIG. 18 is a top view of the single pipe assembly depicted in FIG. 13 for pump training configured for utilization mounted on a portable water tank; and

FIG. 19 is a bottom view of the single pipe assembly depicted in FIG. 13 for pump training configured for utilization mounted on a portable water tank.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a fire fighter's water pipe assembly and associated systems and methods for pump training and fire pump training operations. The water pipe assembly is used in the fire service to collect and recirculate water during fire pump training operations.

The water pipe assembly, and associated systems and methods, are intended for fire departments conducting practical, fire pump training with flowing water to collect discharged water from attack lines into a portable water tank. The water pipe assembly provides for the recirculation of water to minimize water usage.

The water pipe assembly includes coupling adapters that convert fire hose thread (NH) to pipe thread (NPT). The water pipe assembly is rated to withstand fire pump pressures. In various embodiments, the water pipe assembly is manufactured from PVC, steel, or aluminum using glue, welding, compression fittings, or threaded connections for fabrication. The water pipe assembly includes an additional coupling that converts NPT to NH so a fire department nozzle can be attached and discharged into a portable water tank to obtain accurate flow rates used by fire department.

Once the water has been collected by means of the water pipe assembly and utilization of a portable water tank, it can be removed by the same fire truck discharging the water (a one-truck method) or a separate fire truck (a two-truck method) using standard fire department drafting techniques. The water is then recirculated, creating a closed system where the only water usage is what water is left in the fire hose and what is unable to be drafted from the portable water tank when the training has concluded.

Use of a water pipe assembly with these methods and process steps is opposed to the standard fire department technique where water is not collected during fire department training and is discharged down a storm drain or into a grassy or wooded area, creating high water usage, especially when multiple personnel need to train on a particular training evolution.

The water pipe assembly is suitable for use with more than one water pipe, creating a “set” of pipes, some varying in size but having the same design generally, simulating the various hose sizes and layouts that fire departments use. A set of pipes will give fire departments flexibility and variables to efficiently train personnel while conducting fire pump operations.

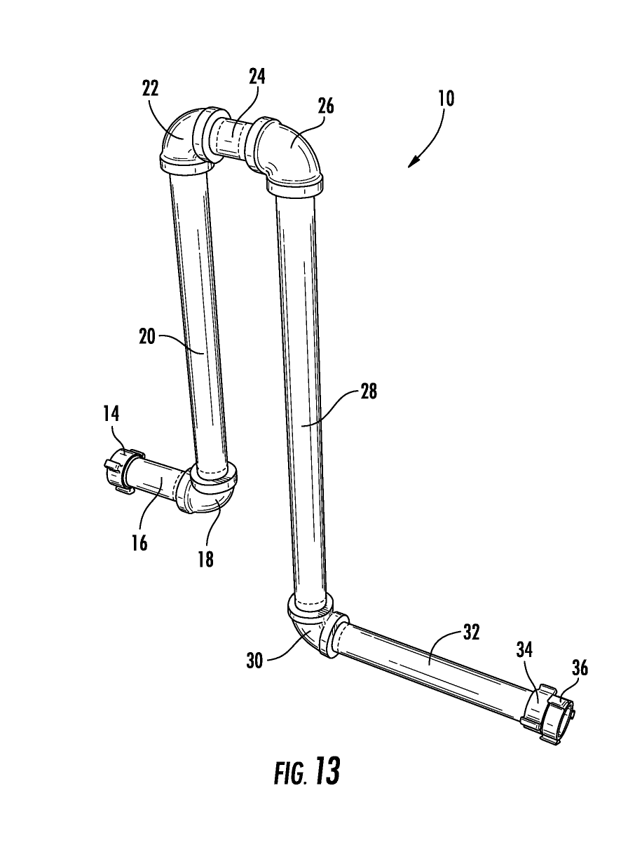

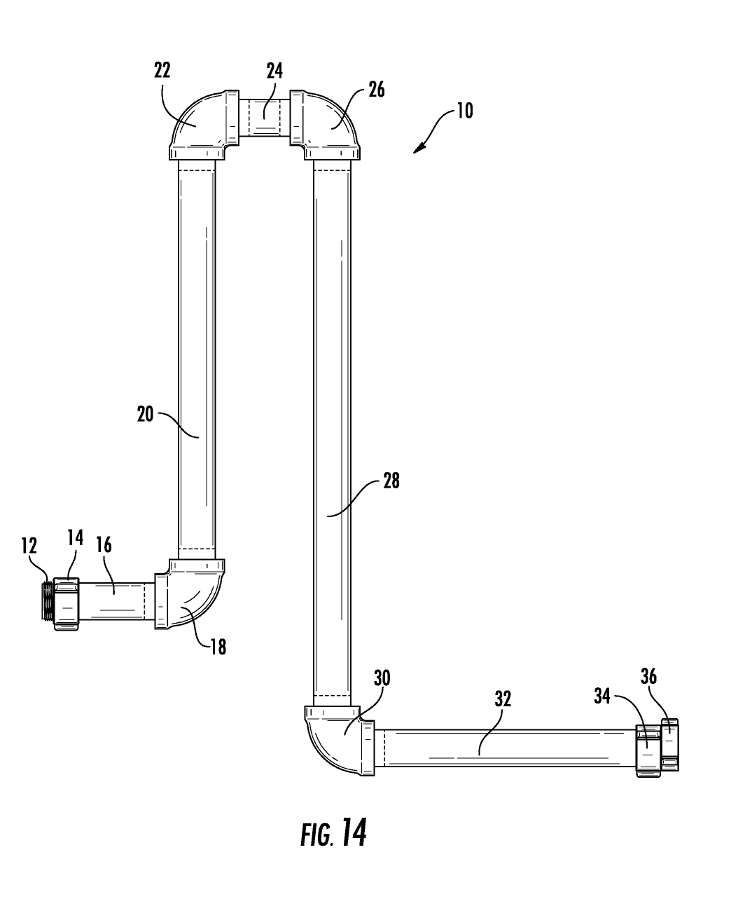

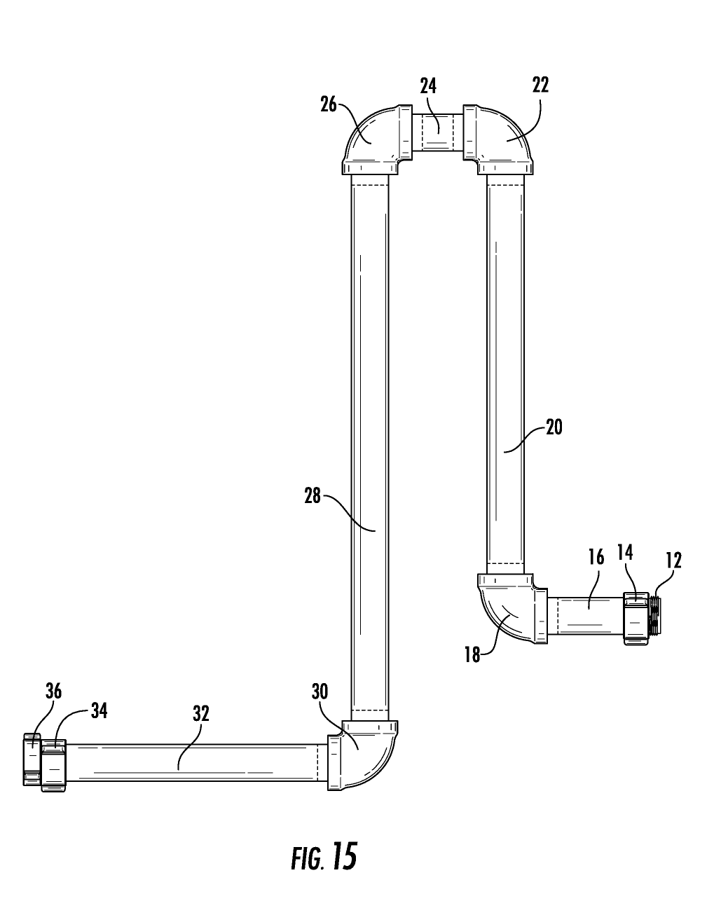

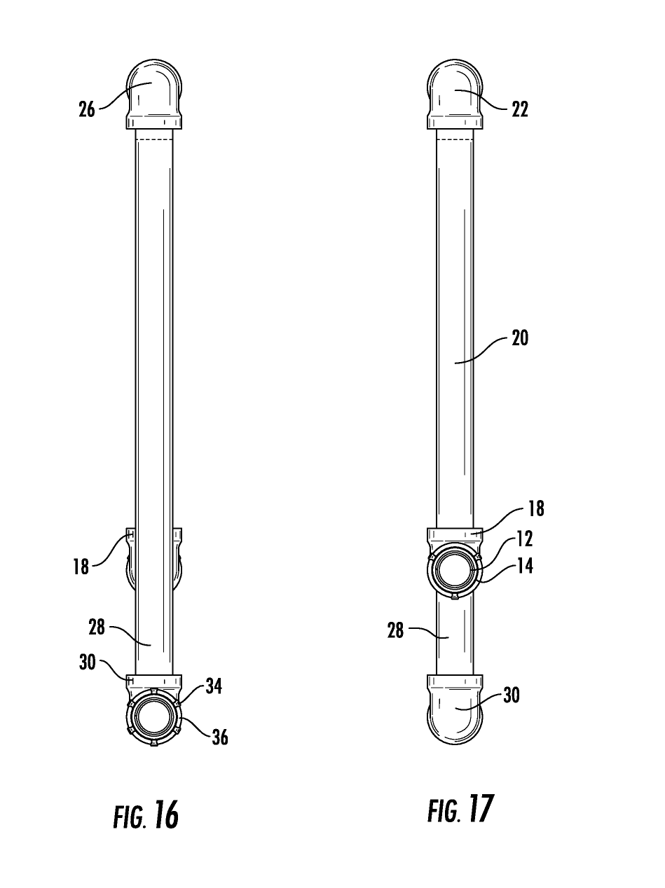

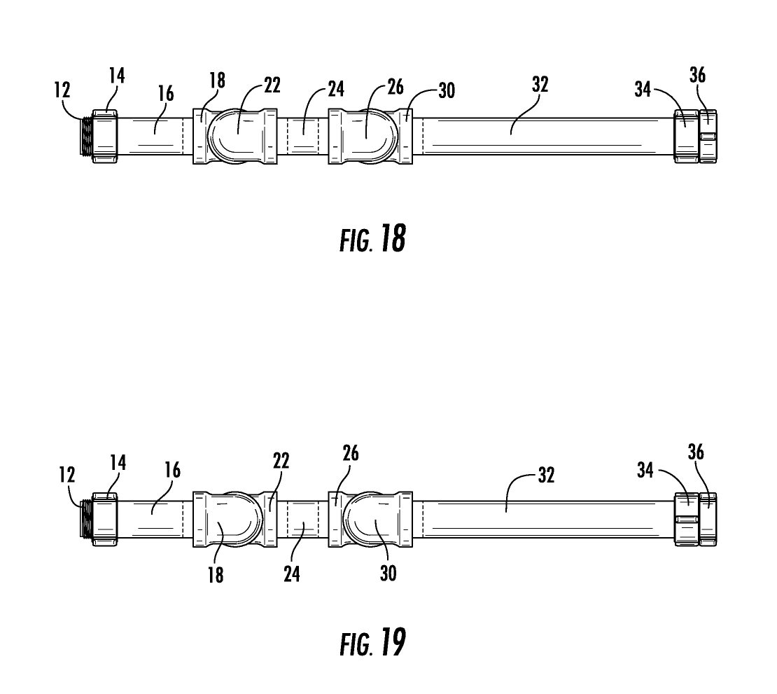

Referring now to FIGS. 13 through 19, a water pipe assembly for pump training 10 is shown. The water pipe assembly for pump training 10 includes a water transfer pipe rated to withstand fire pump pressures. In various embodiments, the water pipe assembly 10 is manufactured from PVC, steel, or aluminum using glue, welding, compression fittings, or threaded connections for fabrication.

The water pipe assembly for pump training 10 includes a first coupling adapter 34, 36 (34 to the pipe, 36 to the fire hose) fluidly coupled and disposed at a first end of the water transfer pipe and configured to convert fire hose thread to pipe thread.

The water pipe assembly for pump training 10 includes a second coupling adapter 14 fluidly coupled and disposed at a second end of the water transfer pipe configured to convert pipe thread to fire hose thread.

The water transfer pipe assembly 10 is further configured and shaped for placement over an edge of a portable water reservoir, such that the water pipe assembly 10 is free standing, without any requirement for mounting hardware.

In at least one embodiment, the water transfer pipe assembly 10 further includes a first horizontal pipe 32 configured to receive the first coupling adapter 34, 36 fluidly coupled and disposed at a first end of the water transfer pipe assembly 10 and configured to convert fire hose thread to pipe thread. The water transfer pipe assembly 10 further includes a first vertical pipe 28 fluidly coupled to the first horizontal pipe 32 at elbow 30 and extending upwardly from the first horizontal pipe 32. The water transfer pipe assembly 10 further includes a second horizontal pipe 24 fluidly coupled at elbow 26 to the first vertical pipe 28 and extending horizontally from the first vertical pipe 28. The water transfer pipe assembly 10 further includes a second vertical pipe 20 fluidly coupled to the second horizontal pipe 24 at elbow 22 and extending downwardly from the second horizontal pipe 24. The water transfer pipe assembly 10 further includes a third horizontal pipe 16 fluidly coupled to the second vertical pipe 20 at elbow 18 and extending horizontally from the second vertical pipe 20.

The first horizontal pipe 32, first vertical pipe 28, second horizontal pipe 24, second vertical pipe 20, third horizontal pipe 16 are fluidly coupled by a ninety degree elbows 30, 26, 22, 18. The first horizontal pipe 32, first vertical pipe 28, second horizontal pipe 24, second vertical pipe 20, third horizontal pipe 16 are collectively form a shape adapted for placement over a portable water reservoir.

The unique configuration and shape of the water pipe assembly for pump training 10 allows a pressure pushback on the device as it is placed over a rim of the portable water reservoir. This provides additional stabilization to the water pipe assembly for pump training 10.

In at least one embodiment of the water pipe assembly for pump training 10, the first coupling adapter 34, 36 fluidly coupled and disposed at a first end of the water transfer pipe and configured to convert fire hose thread to pipe thread further comprises a female national hose thread (NH) to female national pipe tapered (NPT) swivel inlet, thereby to fluidly couple fire hose into pipe.

In at least one embodiment of the water pipe assembly for pump training 10, the second coupling adapter 14, 12 fluidly coupled and disposed at a second end of the water transfer pipe configured to convert pipe thread to fire hose thread 12 further comprises a female national pipe tapered (NPT) to male national hose thread (NH) rigid outlet, thereby to fluidly couple pipe to fire nozzle.

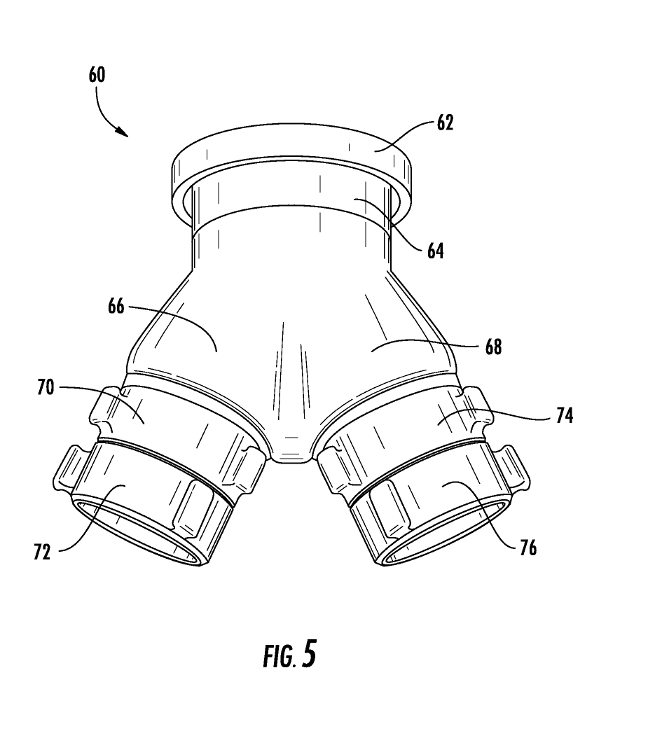

In at least one embodiment of the water pipe assembly for pump training 10, the first coupling adapter 34, 36 fluidly coupled and disposed at a first end of the water transfer pipe and configured to convert fire hose thread to pipe thread further includes a Siamese adapter 60 (as depicted in FIG. 5) such that it is configured to receive input from two fire hoses. The Siamese adapter 60 includes a base 64 and coupling ring 62 to fluidly couple to an adapter, such as the first coupling adapter 34, 36. The Siamese adapter 60 provides for the input of two fire hoses through channels 66, 68 to for a single flow output. The first and second fire hoses that couple to a Siamese adapter 60 are coupled with adapter rings 70, 72 and 74, 76.

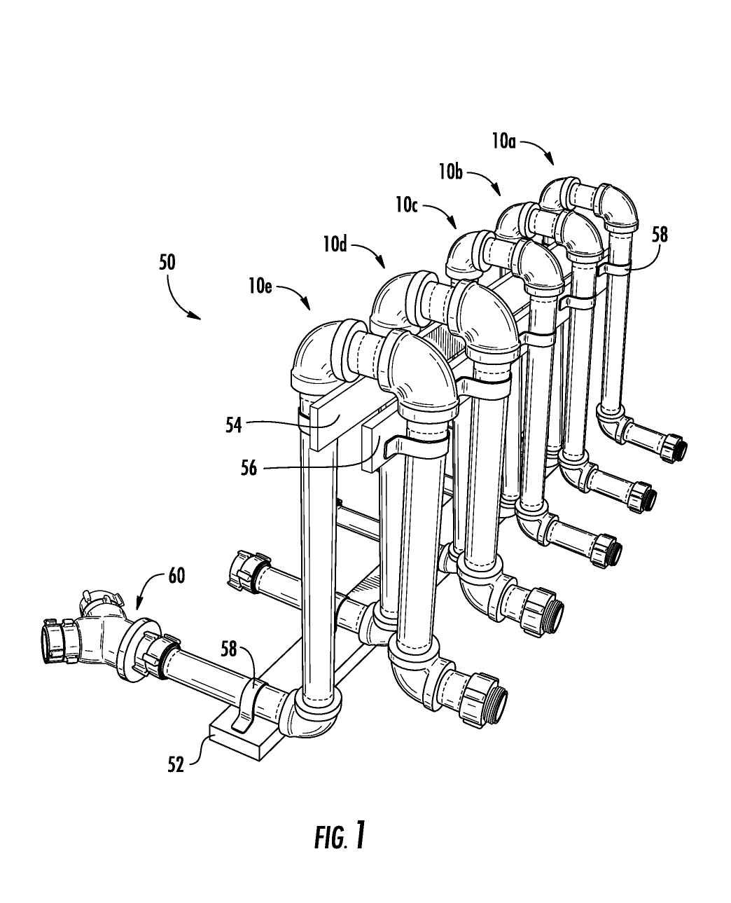

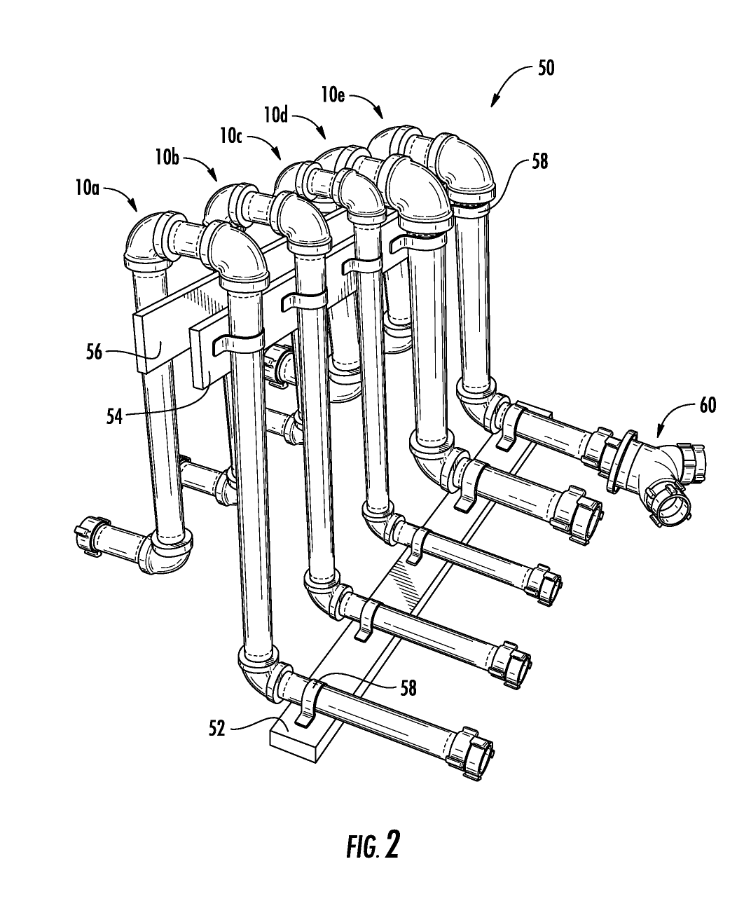

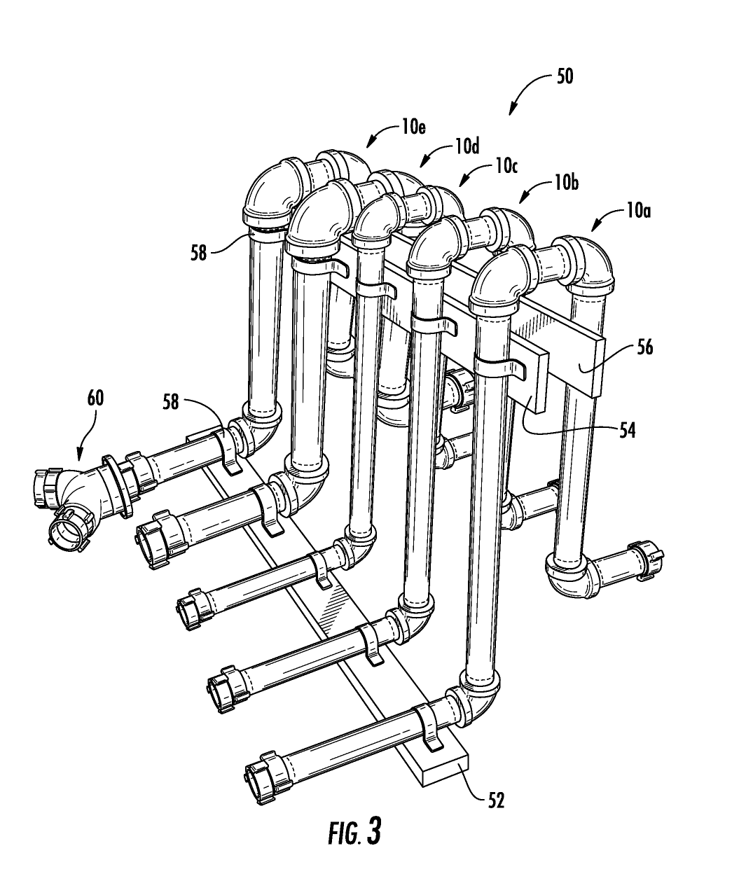

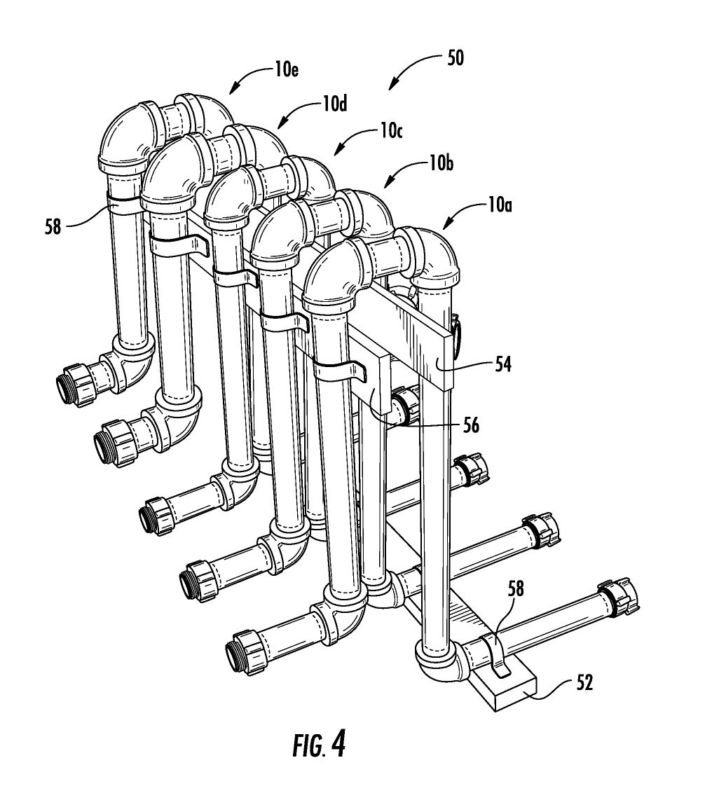

Referring now to FIGS. 1 to 4, a multiple water pipe assembly system 50 for pump training is shown. The multiple water pipe assembly system 50 includes a plurality of water pipe assemblies 10a, 10b, 10c, 10d, and 10e. Each water pipe assembly 10a, 10b, 10c, 10d, 10e includes: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread.

In at least one embodiment of the multiple water pipe assembly system 50 for pump training, each of the plurality of water pipe assemblies 10a, 10b, 10c, 10d, and 10e is varied in size to accommodate the varying size of fire hoses used by fire departments. By way of example, pipe diameters can include 1½″, 2½″, 3½″ and the like.

In at least one embodiment, the multiple water pipe assembly system 50 for pump training further includes a base 52. The base 52 is a surface upon which each of the plurality of water pipe assemblies 10a, 10b, 10c, 10d, and 10e is mounted, such that the plurality of water pipe assemblies 10a, 10b, 10c, 10d, and 10e are anchored together as an assembly, and such that the assembly forms a shape suitable to mount over an edge of a portable water reservoir.

In at least one embodiment, the multiple water pipe assembly system 50 for pump training also includes an inner bracket 56. Upon the inner bracket 56 each of the plurality of water pipe assemblies 10a, 10b, 10c, 10d, and 10e is mounted, such that the plurality of water pipe assemblies 10a, 10b, 10c, 10d, and 10e are anchored together as an assembly, and such that the assembly forms a shape suitable to mount over an edge of a portable water reservoir. The inner mount 56 is disposed on a side of the plurality of water pipe assemblies 10a, 10b, 10c, 10d, and 10e internal to the portable water reservoir when utilized with the portable water reservoir.

In at least one embodiment, the multiple water pipe assembly system for pump training further includes an outer bracket 54. Upon the outer bracket 54 each of the plurality of water pipe assemblies 10a, 10b, 10c, 10d, and 10e is mounted, such that the plurality of water pipe assemblies 10a, 10b, 10c, 10d, and 10e are anchored together as an assembly, and such that the assembly forms a shape suitable to mount over an edge of a portable water reservoir. The outer mount 56 disposed on a side of the plurality of water pipe assemblies 10a, 10b, 10c, 10d, and 10e external to the portable water reservoir when utilized with the portable water reservoir.

In order to secure the various water pipe assemblies 10a, 10b, 10c, 10d, and 10e to the base 52, inner bracket 56, and/or outer bracket 54, a bracket 58 is utilized.

In at least one embodiment, each of the plurality of water pipe assemblies 10a, 10b, 10c, 10d, and 10e further includes: a first horizontal pipe 32 configured to receive the first coupling adapter 34, 36 fluidly coupled and disposed at a first end of the water transfer pipe assembly 10 and configured to convert fire hose thread to pipe thread. The water transfer pipe assembly 10 further includes a first vertical pipe 28 fluidly coupled to the first horizontal pipe 32 at elbow 30 and extending upwardly from the first horizontal pipe 32. The water transfer pipe assembly 10 further includes a second horizontal pipe 24 fluidly coupled at elbow 26 to the first vertical pipe 28 and extending horizontally from the first vertical pipe 28. The water transfer pipe assembly 10 further includes a second vertical pipe 20 fluidly coupled to the second horizontal pipe 24 at elbow 22 and extending downwardly from the second horizontal pipe 24. The water transfer pipe assembly 10 further includes a third horizontal pipe 16 fluidly coupled to the second vertical pipe 20 at elbow 18 and extending horizontally from the second vertical pipe 20.

In at least one embodiment, each of the plurality of water pipe assemblies 10a, 10b, 10c, 10d, and 10e includes the first coupling adapter 34, 36 fluidly coupled and disposed at a first end of the water transfer pipe and configured to convert fire hose thread to pipe thread in each of the plurality of water pipe assemblies further comprises a female national hose thread (NH) to female national pipe tapered (NPT) swivel inlet, thereby to fluidly couple fire hose into pipe; and wherein the second coupling adapter 14, 12 fluidly coupled and disposed at a second end of the water transfer pipe configured to convert pipe thread to fire hose thread 12 in each of the plurality of water pipe assemblies further comprises a female national pipe tapered (NPT) to male national hose thread (NH) rigid outlet, thereby to fluidly couple pipe to fire nozzle.

In another exemplary embodiment, the technology described herein provides a method for pump training utilizing a water pipe assembly 10. The method includes: utilizing a water pipe assembly 10 for pump training comprising: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread; coupling the first coupling adapter to a fire hose; and coupling the second coupling adapter to a fire nozzle.

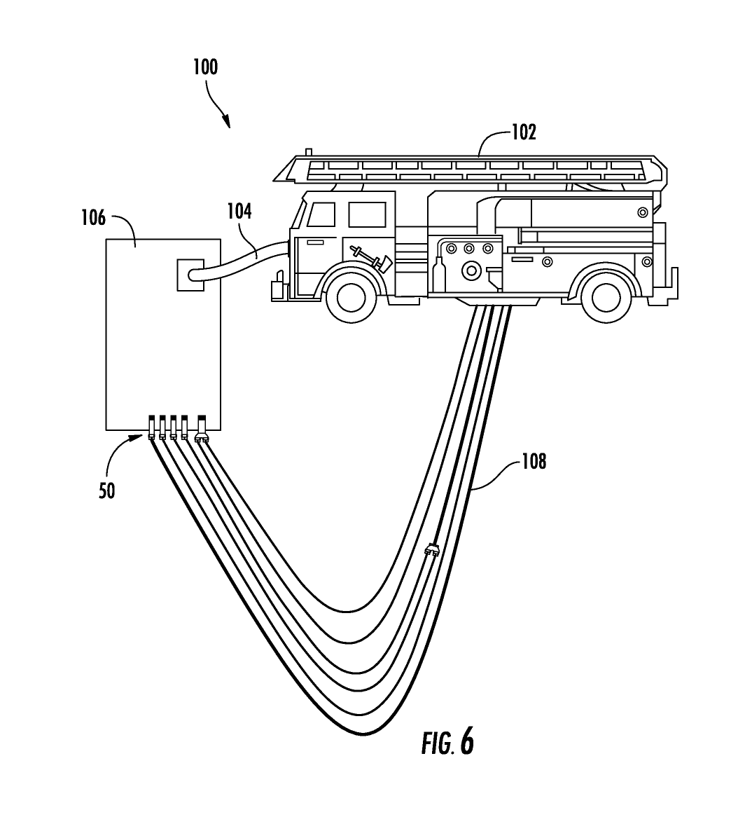

Referring now to FIG. 6, in at least one embodiment of the method for pump training utilizing a water pipe assembly 10, a one-truck method 100 is utilized. The “one-truck” method 100 further includes utilizing a single fire truck 102, such as a source pumper or an attack pumper, and utilizing an on-board water tank disposed within the single fire truck 102. The one-truck method 100 utilizes a portable water tank 106. The “one-truck” method 100 further includes pumping from the single fire truck 102 to the water pipe assembly 50, through a multiplicity of attack hoses 108, and subsequently the portable water tank 106. The “one-truck” method 100 further includes drafting from the portable water tank 106 to the single fire truck 102 such that water is recirculated. The drafting occurs through a hard suction hose 104.

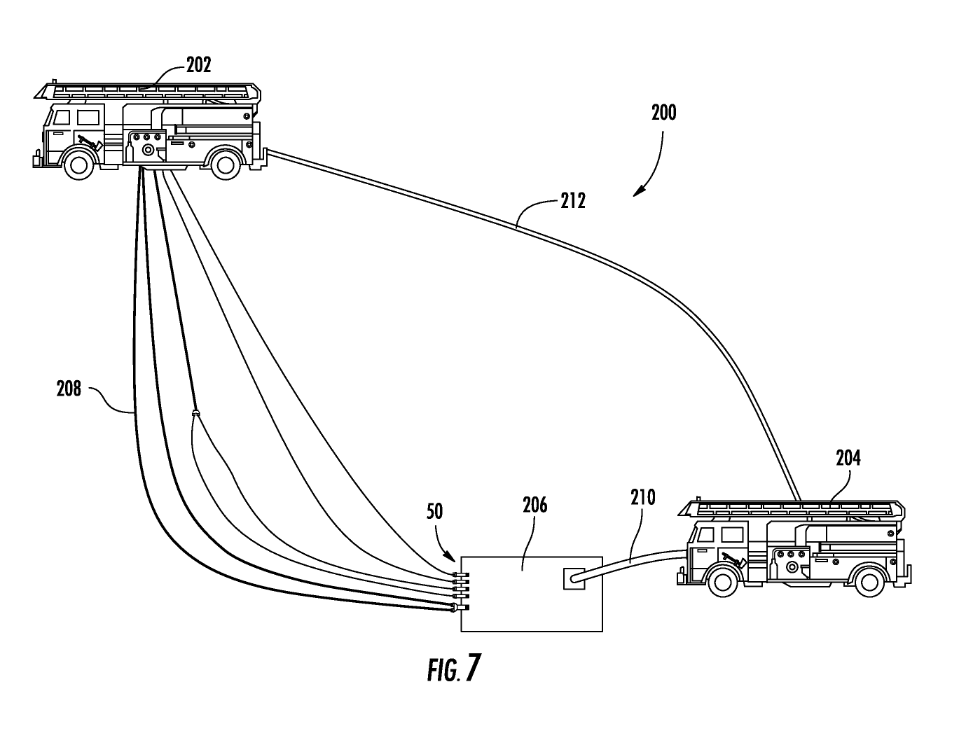

Referring now to FIG. 7, in at least one embodiment of the method for pump training utilizing a water pipe assembly 10, a two-truck method is utilized. The “two-truck” method 200 includes utilizing a pair of fire trucks, a first truck being attack pumper 202, and a second truck being a source pumper 204 and utilizing an on-board water tank disposed within each fire truck 202, 204. The “two-truck” method 200 includes utilizing a portable water tank 206. The “two-truck” method 200 includes pumping from the first fire truck, the attack pumper 202, to the water pipe assembly 50, through a multiplicity of attack hoses 208, and subsequently the portable water tank 206. The “two-truck” method 200 includes drafting from the portable water tank 206, through hard suction hose 210, to the second fire truck, the source pumper 204, such that water is recirculated. The “two-truck” method 200 includes supplying water from the second truck, the source pumper 204, to the first truck, the attack pumper 202, through a supply hose 212.

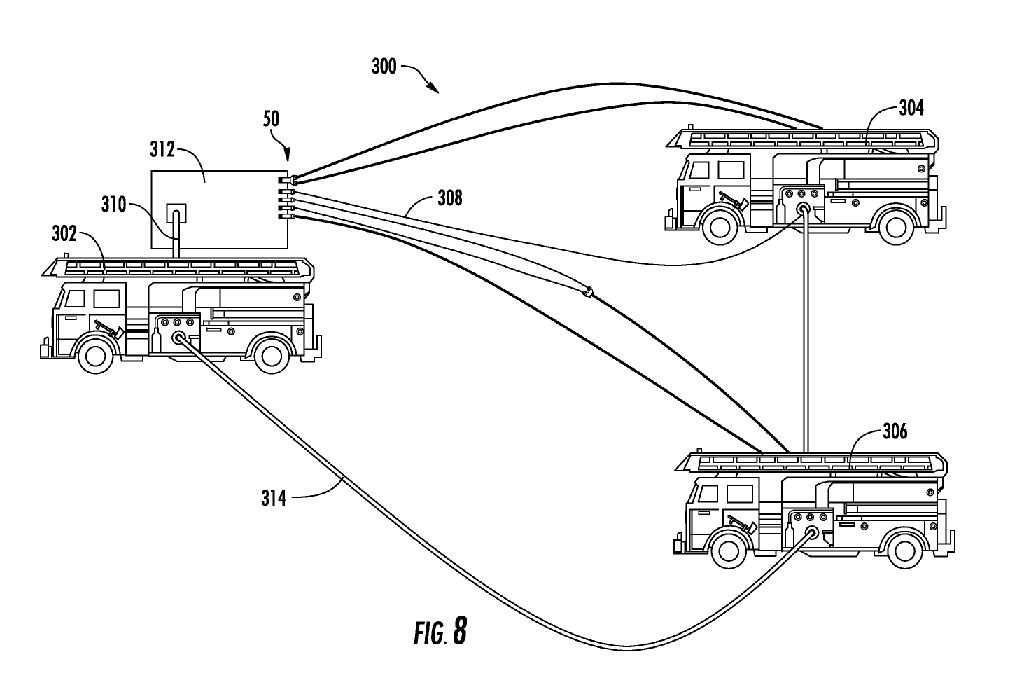

Referring now to FIG. 8, in at least one embodiment of the method for pump training utilizing a water pipe assembly, a dual-pumping method 300 is utilized. The “dual pumping” method 300 includes utilizing a trio of fire trucks, a first truck being a first attack pumper 306, a second truck being a second attack pumper 304, and a third truck being a source pumper 302 and utilizing an on-board water tank disposed within each fire truck 306, 304, 302. The “dual pumping” method 300 includes utilizing a portable water tank 312. The “dual pumping” method 300 includes pumping from the first fire truck 306 and the second fire truck 304 to the water pipe assembly 50, through a multiplicity of attack hoses 308, and subsequently to the portable water tank 312. A soft-suction hose can be utilized between the first fire truck 306 and the second fire truck 304. The “dual pumping” method 300 includes drafting from the portable water tank 312 to the third fire truck, the source pumper 302, through hard suction hose 310. The “dual pumping” method 300 includes pumping utilizing relay pumping and pumping utilizing dual pumping. A supply hose 314 is utilized between the third fire truck, the source pumper 302 and the first truck, first attack pumper 306.

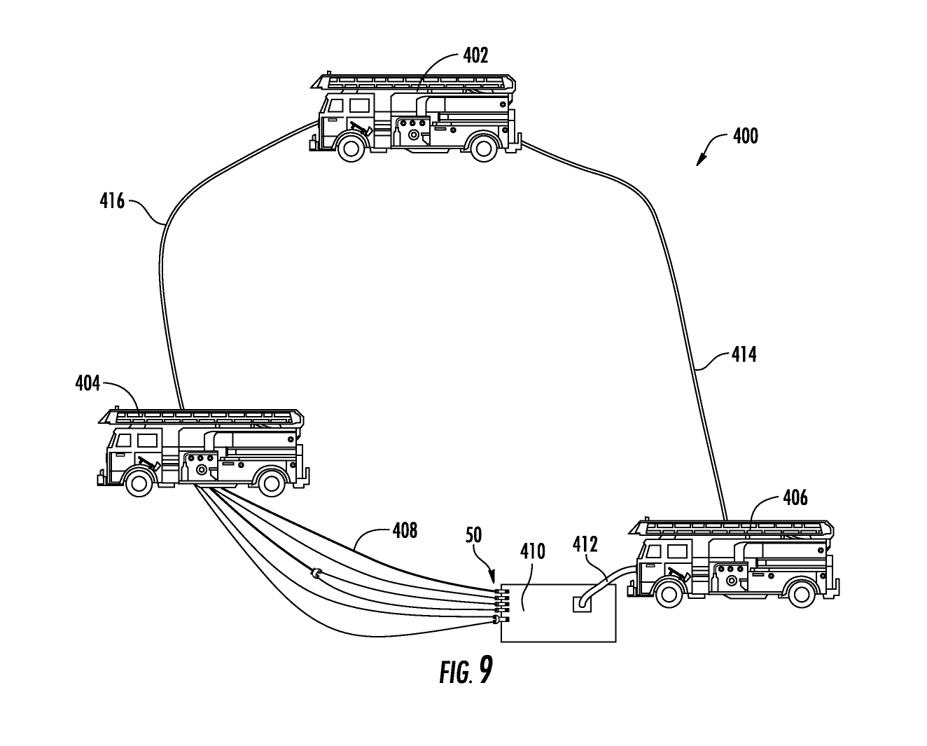

Referring now to FIG. 9, in at least one embodiment of the method for pump training utilizing a water pipe assembly 10, a relay pumping method 400 is shown. The “relay-pumping” method further includes utilizing a trio of fire trucks, a first truck being an attack pumper 404, a second truck being a relay pumper 402, and a third truck being a source pumper 406 and utilizing an on-board water tank disposed within each fire truck, 404, 402, 406. The “relay-pumping” method further includes pumping from the first fire truck, the attack pumper 404, to the water pipe assembly 50, through a multiplicity of attack hoses 408, and subsequently to the portable water tank 410. The “relay-pumping” method further includes drafting from the portable water tank 410 to the third fire truck, the source pumper 406 through hard suction hose 412. The “relay-pumping” method further includes pumping utilizing relay pumping. The “relay-pumping” method further includes pumping from the source pumper 406 to the relay pumper 402, through supply/relay hose 414. The “relay-pumping” method further includes pumping from the relay pumper 402 to the attack pumper 404 through supply/relay hose 416.

Referring now to FIG. 10, in at least one embodiment of the method for pump training utilizing a water pipe assembly 10 utilizing, a shuttle operations method 500 is shown. The “shuttle operations” method further includes utilizing a trio of fire trucks, a first truck being an attack pumper 504, a second truck being a water tender 502, and a third truck being a source pumper 506 and utilizing an on-board water tank disposed within each fire truck 504, 502, 506. The “shuttle operations” method also includes pumping from the first fire truck, the attack pumper 504, to the water pipe assembly 50 and subsequently the portable water tank 510 through a multiplicity of attack hoses 508. The “shuttle operations” method further includes drafting from the portable water tank 510, through hard suction hose 512, to the third fire truck, the source pumper 506. The “shuttle operations” method further includes pumping to a water tender 502, from the source pumper 506 through quick connect lines 514. The “shuttle operations” method further includes tendering water to a water dump site 518. The “shuttle operations” method further includes drafting from the water dump site 518, through hard suction hose 520, to the first fire truck, the attach pumper 504.

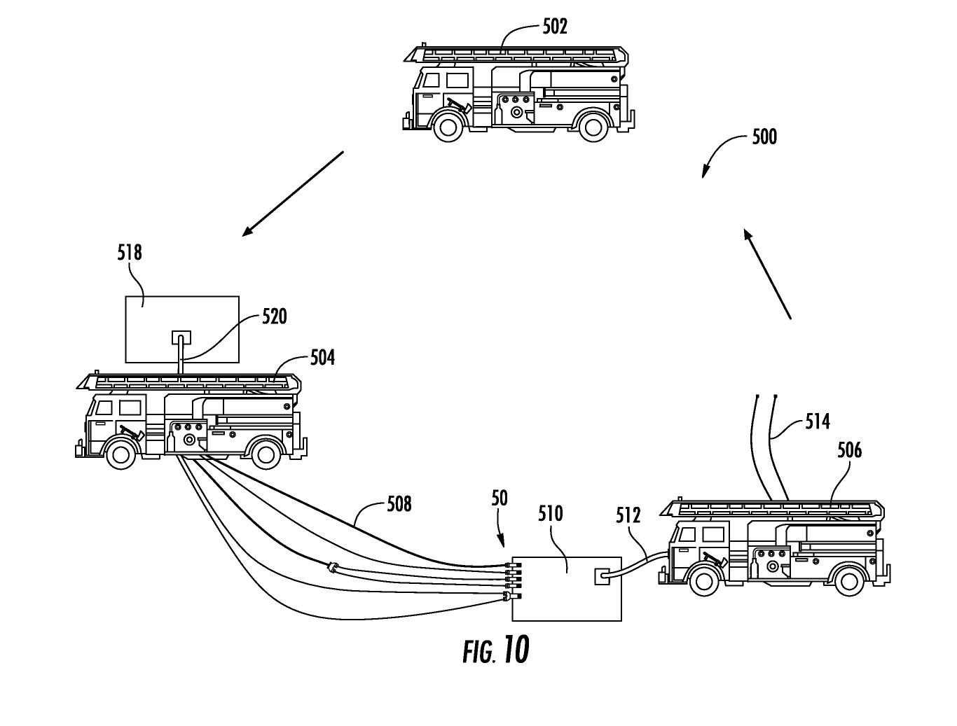

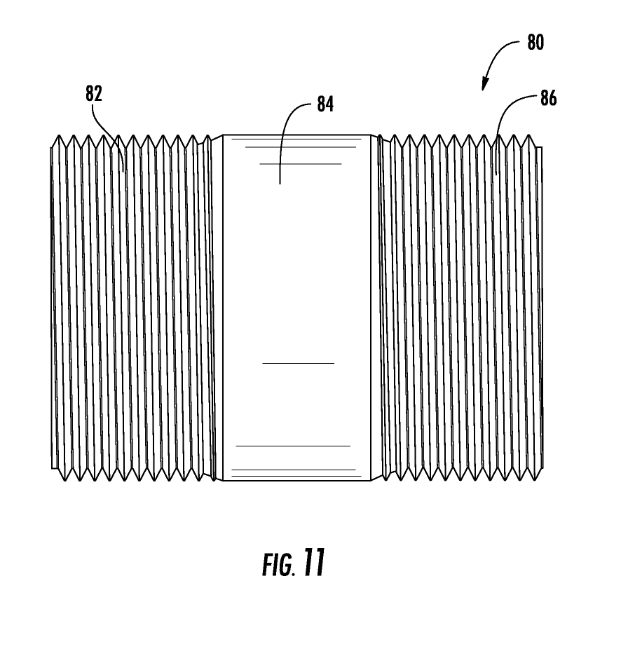

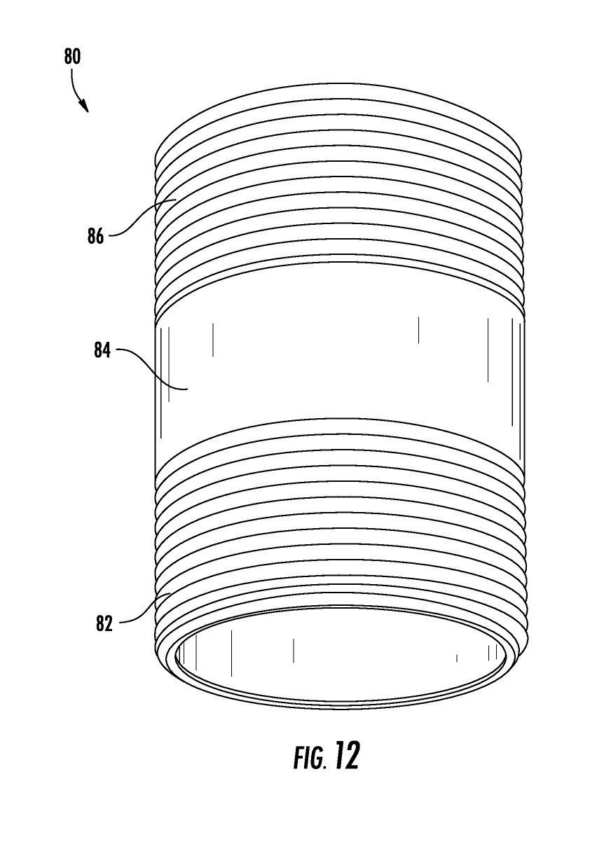

Referring now to FIGS. 11 and 12, a pipe nipple 80 is shown. The pipe nipple 80 provides for coupling. Area 84, which is not threaded, couples first thread area 82 to second thread area 86. As shown, pipe nipple 80 is NPT male.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A water pipe assembly for pump training, the water pipe assembly comprising:
a water transfer pipe rated to withstand fire pump pressures;
a first coupling adapter fluidly coupled and disposed at a first end of the water transfer pipe and configured to convert fire hose thread to pipe thread; and
a second coupling adapter fluidly coupled and disposed at a second end of the water transfer pipe configured to convert pipe thread to fire hose thread.

2. The water pipe assembly of claim 1, wherein the water transfer pipe is further configured and shaped for placement over an edge of a portable water reservoir, such that the water pipe assembly is free standing, without any requirement for mounting hardware.

3. The water pipe assembly of claim 1, wherein the water transfer pipe is comprised of aluminum.

4. The water pipe assembly of claim 1, wherein the water transfer pipe further comprises:
a first horizontal pipe configured to receive the first coupling adapter fluidly coupled and disposed at a first end of the water transfer pipe and configured to convert fire hose thread to pipe thread;
a first vertical pipe fluidly coupled to the first horizontal pipe and extending upwardly from the first horizontal pipe;
a second horizontal pipe fluidly coupled to the first vertical pipe and extending horizontally from the first vertical pipe;
a second vertical pipe fluidly coupled to the second horizontal pipe and extending downwardly from the second horizontal pipe; and
a third horizontal pipe fluidly coupled to the second vertical pipe and extending horizontally from the second vertical pipe;
wherein the first horizontal pipe, first vertical pipe, second horizontal pipe, second vertical pipe, third horizontal pipe are fluidly coupled by a ninety degree elbow; and
wherein the first horizontal pipe, first vertical pipe, second horizontal pipe, second vertical pipe, third horizontal pipe are collectively form a shape adapted for placement over a portable water reservoir.

5. The water pipe assembly of claim 1, wherein the first coupling adapter fluidly coupled and disposed at a first end of the water transfer pipe and configured to convert fire hose thread to pipe thread further comprises a female national hose thread (NH) to female national pipe tapered (NPT) swivel inlet, thereby to fluidly couple fire hose into pipe.

6. The water pipe assembly of claim 1, wherein the second coupling adapter fluidly coupled and disposed at a second end of the water transfer pipe configured to convert pipe thread to fire hose thread further comprises a female national pipe tapered (NPT) to male national hose thread (NH) rigid outlet, thereby to fluidly couple pipe to fire nozzle.

7. The water pipe assembly of claim 1, wherein the first coupling adapter fluidly coupled and disposed at a first end of the water transfer pipe and configured to convert fire hose thread to pipe thread further comprises a Siamese adapter such that it is configured to receive input from two fire hoses.

8. A multiple water pipe assembly system for pump training, the multiple water pipe assembly system comprising:
a plurality of water pipe assemblies, each water pipe assembly comprising: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread.

9. The multiple water pipe assembly system of claim 8, wherein each of the plurality of water pipe assemblies is varied in size to accommodate the varying size of fire hoses used by fire departments.

10. The multiple water pipe assembly system of claim 8, further comprising:
a base upon which each of the plurality of water pipe assemblies is mounted, such that the plurality of water pipe assemblies are anchored together as an assembly, and such that the assembly forms a shape suitable to mount over an edge of a portable water reservoir.

11. The multiple water pipe assembly system of claim 8, further comprising:
an inner bracket upon which each of the plurality of water pipe assemblies is mounted, such that the plurality of water pipe assemblies are anchored together as an assembly, and such that the assembly forms a shape suitable to mount over an edge of a portable water reservoir, the inner mount disposed on a side of the plurality of water pipe assemblies internal to the portable water reservoir when utilized with the portable water reservoir.

12. The multiple water pipe assembly system of claim 8, further comprising:
an outer bracket upon which each of the plurality of water pipe assemblies is mounted, such that the plurality of water pipe assemblies are anchored together as an assembly, and such that the assembly forms a shape suitable to mount over an edge of a portable water reservoir, the outer mount disposed on a side of the plurality of water pipe assemblies external to the portable water reservoir when utilized with the portable water reservoir.

13. The multiple water pipe assembly system of claim 8, wherein each of the plurality of water pipe assemblies further comprises:
a first horizontal pipe configured to receive the first coupling adapter fluidly coupled and disposed at a first end of the water transfer pipe and configured to convert fire hose thread to pipe thread;
a first vertical pipe fluidly coupled to the first horizontal pipe and extending upwardly from the first horizontal pipe;
a second horizontal pipe fluidly coupled to the first vertical pipe and extending horizontally from the first vertical pipe;
a second vertical pipe fluidly coupled to the second horizontal pipe and extending downwardly from the second horizontal pipe; and
a third horizontal pipe fluidly coupled to the second vertical pipe and extending horizontally from the second vertical pipe;
wherein the first horizontal pipe, first vertical pipe, second horizontal pipe, second vertical pipe, third horizontal pipe are fluidly coupled by a ninety degree elbow; and
wherein the first horizontal pipe, first vertical pipe, second horizontal pipe, second vertical pipe, third horizontal pipe are collectively form a shape adapted for placement over a portable water reservoir.

14. The multiple water pipe assembly system of claim 8, wherein the first coupling adapter fluidly coupled and disposed at a first end of the water transfer pipe and configured to convert fire hose thread to pipe thread in each of the plurality of water pipe assemblies further comprises a female national hose thread (NH) to female national pipe tapered (NPT) swivel inlet, thereby to fluidly couple fire hose into pipe; and wherein the second coupling adapter fluidly coupled and disposed at a second end of the water transfer pipe configured to convert pipe thread to fire hose thread in each of the plurality of water pipe assemblies further comprises a female national pipe tapered (NPT) to male national hose thread (NH) rigid outlet, thereby to fluidly couple pipe to fire nozzle.

15. A method for pump training utilizing a water pipe assembly, the method comprising:
utilizing a water pipe assembly for pump training comprising: a water transfer pipe rated to withstand fire pump pressures; a first coupling adapter fluidly coupled and disposed at a first end of the water transfer pipe and configured to convert fire hose thread to pipe thread; and a second coupling adapter fluidly coupled and disposed at a second end of the water transfer pipe configured to convert pipe thread to fire hose thread;
coupling the first coupling adapter to a fire hose; and
coupling the second coupling adapter to a fire nozzle.

16. The method for pump training utilizing a water pipe assembly of claim 15, further comprising:
utilizing a single fire truck;
utilizing an on-board water tank disposed within the single fire truck;
utilizing a portable water tank;
pumping from the single fire truck to the water pipe assembly and subsequently the portable water tank; and
drafting from the portable water tank to the single fire truck such that water is recirculated.

17. The method for pump training utilizing a water pipe assembly of claim 15, further comprising:
utilizing a pair of fire trucks, a first truck being attack pumper, and a second truck being a source pumper;
utilizing an on-board water tank disposed within each fire truck;
utilizing a portable water tank;
pumping from the first fire truck to the water pipe assembly and subsequently the portable water tank;
drafting from the portable water tank to the second fire truck such that water is recirculated; and
supplying water from the second truck to the first truck.

18. The method for pump training utilizing a water pipe assembly of claim 15, further comprising:
utilizing a trio of fire trucks, a first truck being a first attack pumper, a second truck being a second attack pumper, and a third truck being a source pumper;
utilizing an on-board water tank disposed within each fire truck;
utilizing a portable water tank;
pumping from the first fire truck and the second fire truck to the water pipe assembly and subsequently the portable water tank;
drafting from the portable water tank to the third fire truck, the source pumper;
pumping utilizing relay pumping; and
pumping utilizing dual pumping.

19. The method for pump training utilizing a water pipe assembly of claim 15, further comprising:
utilizing a trio of fire trucks, a first truck being an attack pumper, a second truck being a relay pumper, and a third truck being a source pumper;
utilizing an on-board water tank disposed within each fire truck;
pumping from the first fire truck to the water pipe assembly and subsequently the portable water tank;
drafting from the portable water tank to the third fire truck, the source pumper;
pumping utilizing relay pumping;
pumping from the source pumper to the relay pumper; and
pumping from the relay pumper to the attack pumper.

20. The method for pump training utilizing a water pipe assembly of claim 15, further comprising:
utilizing a trio of fire trucks, a first truck being an attack pumper, a second truck being a water tender, and a third truck being a source pumper;
utilizing an on-board water tank disposed within each fire truck;
pumping from the first fire truck, the attack pumper, to the water pipe assembly and subsequently the portable water tank;
drafting from the portable water tank to the third fire truck, the source pumper;
pumping to a water tender;
tendering water to a water dump site; and
drafting from the water dump site to the first fire truck, the attach pumper;.
